(19) United States
(12) Patent Application Publication
(10) Pub. No.: US 2017/0205039 A1
(43) Pub. Date: Jul. 20, 2017

(54) VEHICLE LAMP APPARATUS AND CONTROL METHOD THEREOF

(71) Applicant: HYUNDAI MOBIS CO., LTD., Seoul (KR)

(72) Inventor: Seong Yeon HAN, Yongin-si (KR)

(73) Assignee: HYUNDAI MOBIS CO., LTD., Seoul (KR)

(21) Appl. No.: 15/405,780

(22) Filed: Jan. 13, 2017

(30) Foreign Application Priority Data
Jan. 14, 2016 (KR) 10-2016-0004480

(51) Int. Cl. F21S 8/10; B60Q 1/14; H05B 33/08

(52) U.S. Cl. CPC F21S 48/1317; H05B 33/0854; B60Q 1/143; F21S 48/115; F21S 48/1225; F21Y 2115/10

(57) ABSTRACT

A vehicle lamp apparatus may include: a first lamp configured to create a low beam pattern in a forward region of a vehicle; and a second lamp configured to irradiate bending light onto a curved road region where the low beam pattern is not formed depending on an SWA (Steering Wheel Angle) of the vehicle, in the forward region of the vehicle, the second lamp may include a second light source including a plurality of LEDs which are independently turned on/off; and a second reflector configured to reflect the bending light of the second light source onto the curved road region.

### CROSS-REFERENCES TO RELATED APPLICATIONS

The present application claims priority to Korean application number 10-2016-0004480, filed on Jan. 14, 2016, which is incorporated by reference in its entirety.

### BACKGROUND OF THE INVENTION

The present invention relates to a vehicle lamp apparatus and a control method thereof, and more particularly, to a vehicle lamp apparatus for ensuring a user's visibility during night driving, and a control method thereof.

In general, a lamp refers to an apparatus that receives power from a battery and generates light. A vehicle lamp apparatus installed in a vehicle irradiates light forward, in order to ensure a driver's visibility.

A halogen lamp or gas-discharge lamp had been used as a light source of the vehicle lamp apparatus. Recently, however, an LED (Light Emitting Diode) which shows high brightness while having power consumption has been frequently used as a light source of the vehicle lamp apparatus.

The vehicle lamp apparatus can create a low beam which is always turned on during night driving and a high beam which is turned on as needed.

Recently, there has been developed a technique which adjusts an irradiation angle of a vehicle lamp apparatus and turns on a low beam according to a driving environment, when a vehicle enters a driving environment such as a curved road where an accident is highly likely to occur. Such a technique can ensure a wide range of visibility, thereby improving a user's driving safety.

However, the conventional vehicle lamp apparatus adjusts the irradiation angle through a separate actuator device. The actuator device may serve as a factor which increases the size of the vehicle lamp apparatus while causing a quality problem in operability.

### SUMMARY OF THE INVENTION

Embodiments of the present invention are directed to a vehicle lamp apparatus which is capable of ensuring a wider range of visibility in a driving environment such as a curved road where an accident is highly likely to occur, without adjusting a lamp irradiation angle through a separate actuator, thereby improving the safety of a vehicle.

In one embodiment, a vehicle lamp apparatus may include: a first lamp configured to create a low beam pattern in a forward region of a vehicle; and a second lamp configured to irradiate bending light onto a curved road region where the low beam pattern is not formed depending on an SWA (Steering Wheel Angle) of the vehicle, in the forward region of the vehicle. The second lamp may include: a second light source including a plurality of LEDs which are independently turned on/off; and a second reflector configured to reflect the bending light of the second light source onto the curved road region.

The low beam pattern may be expanded by the bending light of the second lamp.

The plurality of LEDs included in the second light source may be selectively turned on depending on the SWA.

When the SWA is equal to or more than a preset reference SWA, the entire LEDs may be turned on.

The plurality of LEDs may be turned on/off depending on a preset speed value of the vehicle.

The vehicle lamp apparatus may further include a sensor configured to sense an object around the vehicle. The plurality of LEDs may be selectively turned on according to a sensing signal of the sensor.

The second reflector may have a reflecting surface formed in a direction facing the second light source, and the second reflector may be set to a reflecting angle for irradiating the bending light of the second light source onto the curved road region.

In another embodiment, a control method of a vehicle lamp apparatus may include: checking whether the vehicle lamp apparatus is started; sensing whether an object is present around a vehicle, when the vehicle lamp apparatus is started; and creating a low beam pattern or irradiating bending light when the object is sensed around the vehicle, and creating a high beam when the object is not sensed around the vehicle.

The creating of the low beam pattern may include: creating, by a first lamp of the vehicle lamp apparatus, the low beam pattern or maintaining the created low beam pattern; checking whether a vehicle speed is enabled; checking an SWA of the vehicle when the vehicle speed is equal to or more than a reference speed; and enabling a low beam matrix when the SWA is equal to or more than a reference SWA.

When the vehicle speed is less than the reference speed or the SWA is less than the reference SWA, the first lamp of the vehicle lamp apparatus may create the low beam pattern or maintains the created low beam pattern.

The irradiating of the bending light may include: operating the vehicle lamp apparatus in an ADB (Adaptive Driving Beam) mode; measuring location information of a forward vehicle in the ADB mode; and performing selective turn-on/off by turning on/off LEDs included in a second lamp of the vehicle lamp apparatus, according to the location information of the forward vehicle.

### BRIEF DESCRIPTION OF THE DRAWINGS

FIG. 1 is a conceptual view of a vehicle lamp apparatus in accordance with an embodiment of the present invention.

FIGS. 2A to 2F are diagrams illustrating that LEDs included in a second light source of the vehicle lamp apparatus in accordance with the embodiment of the present invention are selectively turned on.

FIGS. 3A and 3B are diagrams illustrating a low beam pattern and bending light in accordance with the embodiment of the present invention.

FIGS. 4A and 4B are diagrams illustrating a low beam pattern and bending light which are created in a forward region of a vehicle and a curved road region, in accordance with the embodiment of the present invention.

FIG. 5 is a flowchart illustrating a control method of a vehicle lamp apparatus in accordance with an embodiment of the present invention.

FIG. 6 is a control block diagram of the vehicle lamp apparatus in accordance with the embodiment of the present invention.

FIG. 7 is a conceptual view of a second lamp in accordance with first embodiment of the present invention.

FIG. 8 is a conceptual view of a second lamp in accordance with second embodiment of the present invention.

FIG. 9 is a conceptual view of a second lamp in accordance with third embodiment of the present invention.

### DESCRIPTION OF SPECIFIC EMBODIMENTS

Hereafter, exemplary embodiments of the present invention will be described in detail with reference to the accompanying drawings. However, the present invention can be embodied into various forms, and is not limited to the embodiments. In order to clarify the descriptions of the present invention, parts irrelevant to the descriptions are omitted herein, and like reference numerals represent the same components.

In this specification, when an element “comprises” a component, it may indicate that the element does not exclude another component unless referred to the contrary, but can further comprise another component. Furthermore, the term such as “˜unit”, “˜er”, “module” or “block” described in this specification may indicate a unit for processing one or more functions or operations, and the unit may be embodied by hardware, software or a combination of hardware and software.

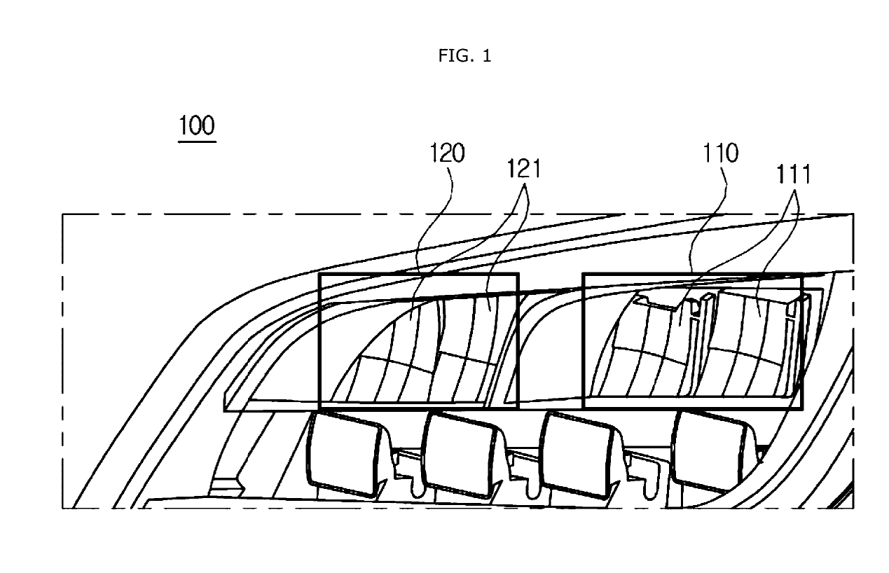

Referring to FIG. 1, a vehicle lamp apparatus 100 in accordance with an embodiment of the present invention may include a first lamp 110 and a second lamp 120. When the first lamp 110 creates a low beam pattern in a forward region of a vehicle and the second lamp 120 irradiates bending light to a curved road region where the low beam pattern is not formed depending on a steering wheel angle (SWA) of the vehicle, in the forward region of the vehicle, the low beam pattern can be expanded to the curved road region by the bending light of the second lamp 120.

Thus, the vehicle lamp apparatus 100 in accordance with the embodiment of the present invention can ensure a wider range of visibility in a driving environment such as a curved road where an accident is highly likely to occur, without adjusting a lamp irradiation angle through a separate actuator. Therefore, the size of the vehicle lamp apparatus can be minimized, and a user who gets a wide range of visibility can safely drive the vehicle, which makes it possible to improve the safety of the vehicle.

The first lamp 110 may serve to create a low beam pattern in the forward region of the vehicle, the low beam pattern being always lit on during night driving of the vehicle. The first lamp 110 may include a first light source (not illustrated), a first reflector 111, a shield (not illustrated) and a first aspheric lens (not illustrated).

The first light source may output light for creating a low beam pattern. The first light source may include an LED package having a plurality of LEDs (Light Emitting Diodes). The light outputted from the first light source may propagate toward the first reflector 111.

The first reflector 111 may reflect the light of the first light source. The first reflector 111 may have a reflecting surface formed in a direction facing the first light source. The light reflected by the reflecting surface of the first reflector 111 may propagate toward the first aspheric lens through the focal point of the first aspheric lens.

The shield may be installed at the focal point of the first aspheric lens, and block a part of the light reflected by the first reflector 111. The shield may block a part of the light outputted from the first light source, such that a low beam pattern is created.

The first aspheric lens may implement a low beam pattern by projecting the light of the first light source, which is not blocked by the shield, onto the forward region of the vehicle. The first aspheric lens may have a surface for receiving light and a source for emitting light. In the first aspheric lens, the incident surface for receiving light may be set to a flat surface, and the surface for emitting light may be set to an aspheric surface. The first aspheric lens may be formed of a transparent optical material such as glass or plastic, but is not limited thereto.

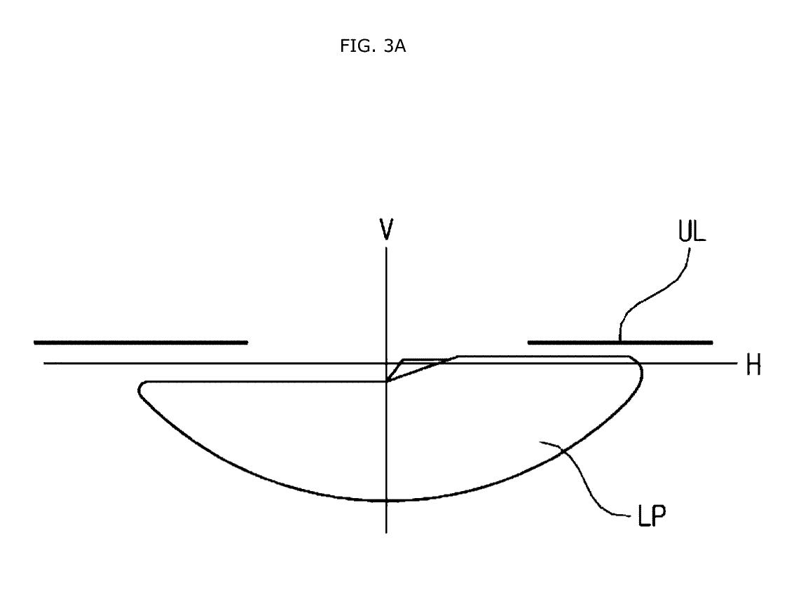

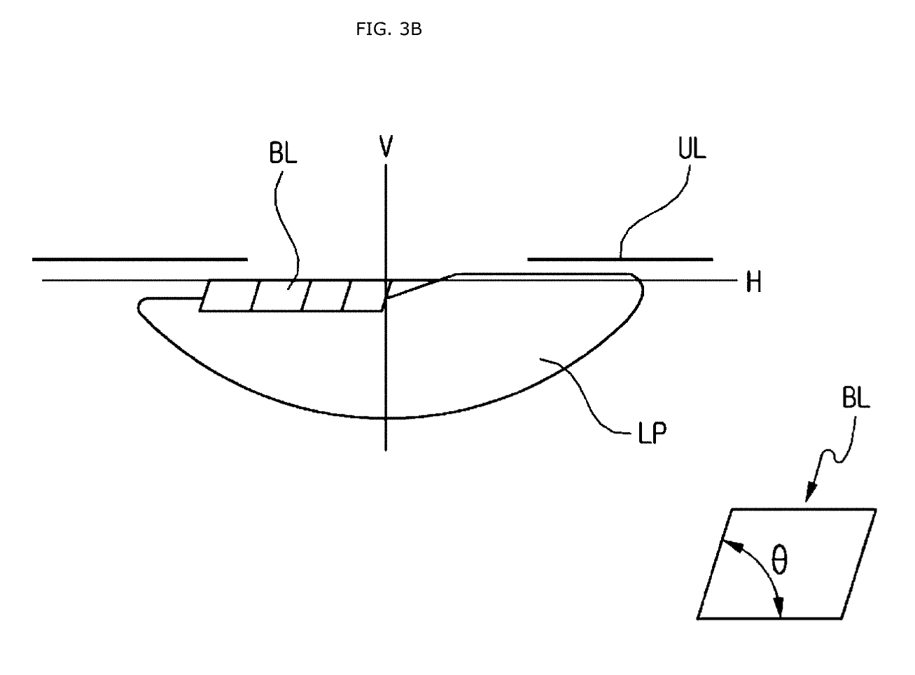

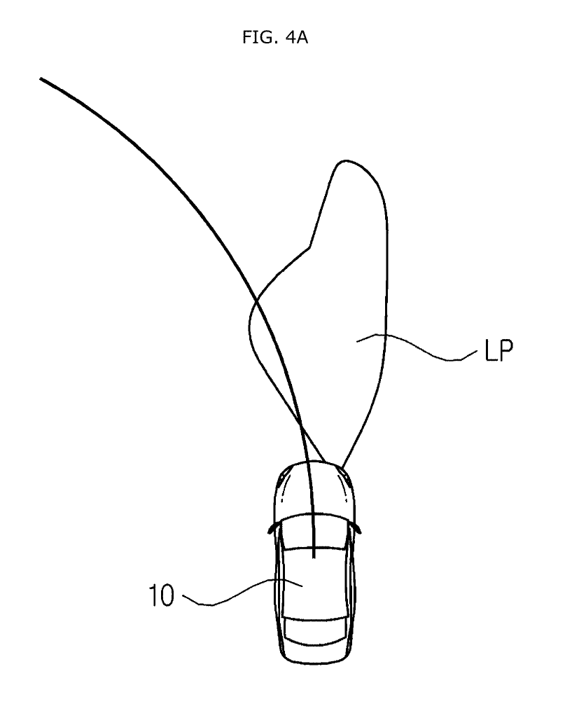

FIG. 3A illustrates a low beam pattern LP created by the first lamp 110. The low beam pattern LP may have a symmetrical shape with respect to a vertical line V corresponding to the central axis of the first lamp 110, while being created under a horizontal line H. The low beam pattern LP may be cut off so that the right top region thereof covers the horizontal line H under the upper limit line UL, and cut off so that the left top region thereof is spaced at a predetermined distance downward from the horizontal line H. The upper limit line UL may be set depending on the characteristic of the vehicle.

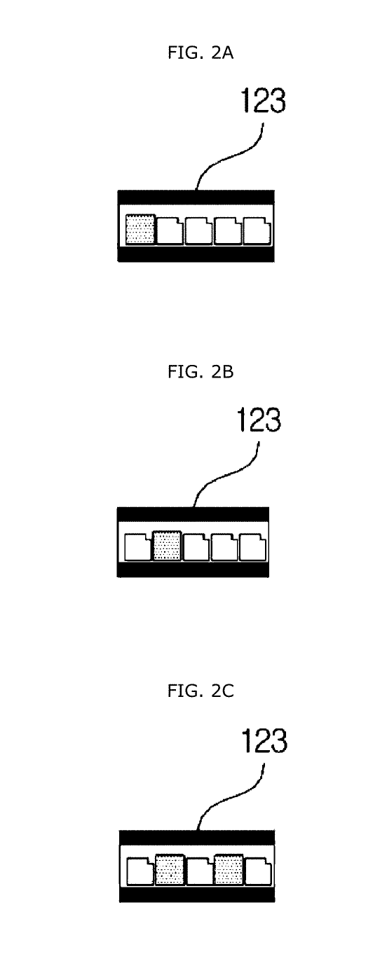

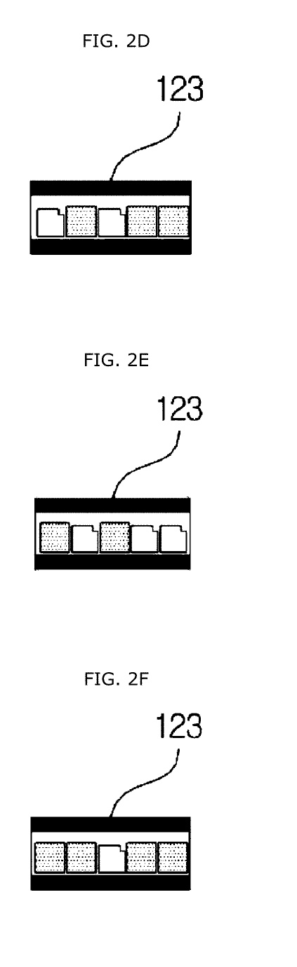

Referring back to FIGS. 1 and 2, the second lamp 120 may serve to irradiate bending light to a curved road region where a low beam pattern is not formed depending on the SWA of the vehicle, in the forward region of the vehicle. The second lamp 120 may include a second light source 123, a second reflector 121 and a second aspheric lens 125.

The second light source 123 may output the above-described bending light. Referring to FIGS. 2A to 2F, the second light source 123 may include an LED package having a plurality of LEDs which are independently turned on/off. The plurality of LEDs in the second light source 123 may be selectively turned on depending on the SWA of the vehicle.

The second light source 123 may include five LEDs, for example. Among the five LEDs, a first LED may be turned on as illustrated in FIG. 2A, a second LED may be turned on as illustrated in FIG. 2B, the second and fourth LEDs may be turned on as illustrated in FIG. 2C, the second, fourth and fifth LEDs may be turned on as illustrated in FIG. 2D, the first and third LEDs may be turned on as illustrated in FIG. 2E, or the first, second, fourth and fifth LEDs may be turned as illustrated in FIG. 2F. However, the present invention is not limited thereto.

In particular, when the SWA of the vehicle is equal to or more than a preset reference SWA, the entire LEDs of the second light source 123 may be turned on. The reference SWA may be set depending on the characteristic of the vehicle.

The plurality of LEDs in the second light source 123 may be turned on/off in consideration of the speed of the vehicle. For example, when the speed of the vehicle is less than a reference speed and two or more LEDs are turned on depending on the SWA of the vehicle, the LEDs may be sequentially turned on at a predetermined speed interval.

Furthermore, when the speed of the vehicle is equal to or more than the reference speed and two or more LEDs are turned on depending on the SWA of the vehicle, the LEDs may be sequentially turned on at a higher speed than the predetermined speed.

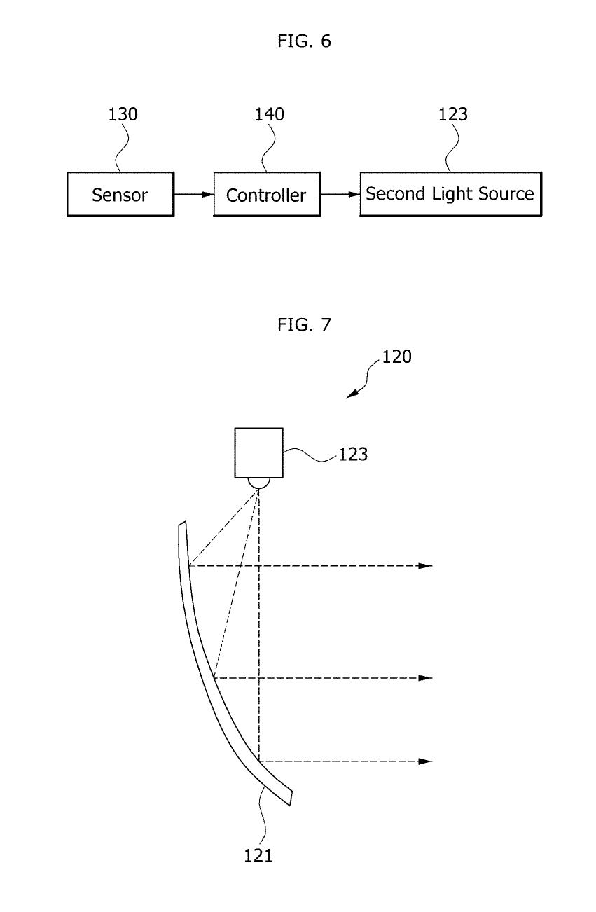

Referring to FIG. 6, the plurality of LEDs in the second light source 123 may be turned on/off in consideration of an object around the vehicle. The vehicle lamp apparatus 100 in accordance with the embodiment of the present invention may further include a sensor 130 for sensing an object around the vehicle. When sensing an object around the vehicle, the sensor 130 may generate a sensing signal.

When the sensor 130 generates a sensing signal, the controller 140 may control the operation of the second light source 123 based on the signal transmitted from the sensor 130. At this time, the plurality of LEDs in the second light source 123 may be selectively turned on according to the operation control of the controller 140 based on the sensing signal of the sensor 130.

Referring to FIG. 7, the second lamp 120 may include a second light source 123 and a second reflector 121. The bending light, which is generated as the plurality of LEDs in the second light source 123 are turned on/off, may propagate toward the second reflector 121.

The second reflector 121 may reflect the bending light of the second light source 123. The second reflector 121 may have a reflecting surface formed in a direction facing the second light source 123. The reflecting surface of the second reflector 121 may be set to a reflecting angle for irradiating the bending light to the curved-road region.

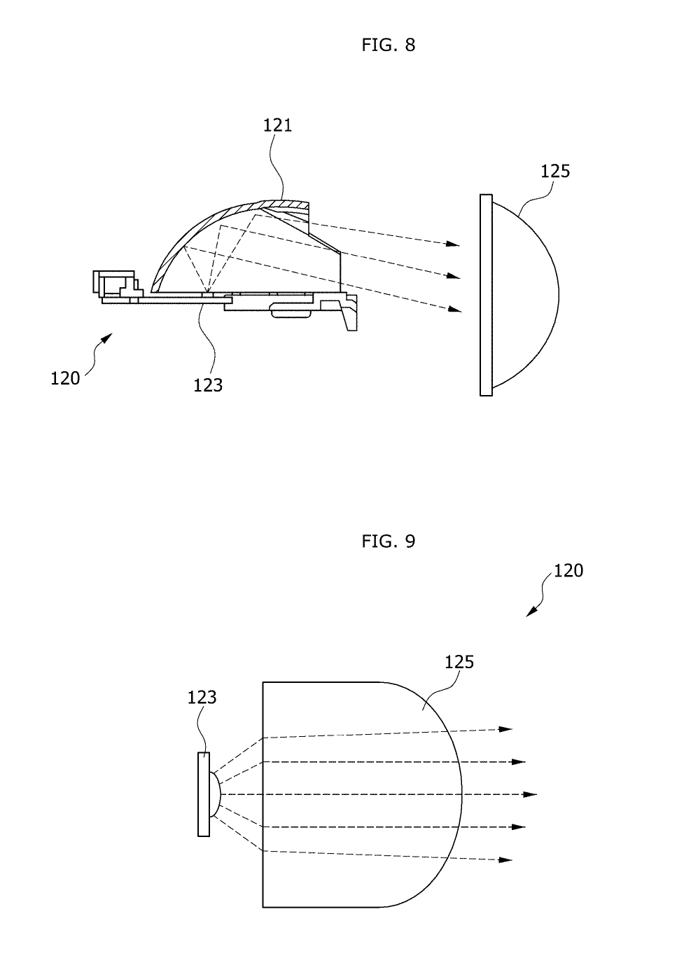

Referring to FIG. 8, the second lamp 120 may include a second light source 123, a second reflector 121 and a second aspheric lens 125. The bending light reflected by the reflecting surface of the second reflector 121 may propagate toward the second aspheric lens 125 through the focal point of the second aspheric lens 125.

The second aspheric lens 125 may project the bending light of the second light source 123 onto the curved-road region where the low beam pattern is not formed, in the forward region of the vehicle. The bending light can expand the low beam pattern to the curved road region, which makes it possible for a user to ensure a wide range of visibility in a driving environment such as a curved road. The second aspheric lens 125 may be made of the same material as the first aspheric lens and have the same shape as the first aspheric lens. However, the second aspheric lens 125 is not limited thereto.

Referring to FIG. 9, the second lamp 120 may include a second light source 123 and a second aspheric lens 125. The second aspheric lens 125 may project the bending light of the second light source 123 onto the curved-road region where the low beam pattern is not formed, in the forward region of the vehicle.

FIG. 3B illustrates the low beam pattern LP formed by the first lamp 110 and the bending light BL irradiated by the second lamp 120. As described with reference to FIG. 3A, the low beam pattern LP may have a symmetrical shape with respect to the vertical line V corresponding to the central axis of the first lamp 110, while being created under the horizontal line H.

The bending light BL may be irradiated between the horizontal line H and the left-top region of the low beam pattern LP. The bending light L may have a beam angle 0 of 15 to 45 degrees. The beam angle θ may be set according to a vehicle height and the curvature of a road. For example, the vehicle height may be set to 670 mm.

The region onto which the bending light BL is irradiated may be set to a region which falls within a horizontal angle of 5 to 20 degrees with respect to the vertical line V. The region onto which the bending light BL is irradiated may be set depending on the characteristic of the vehicle.

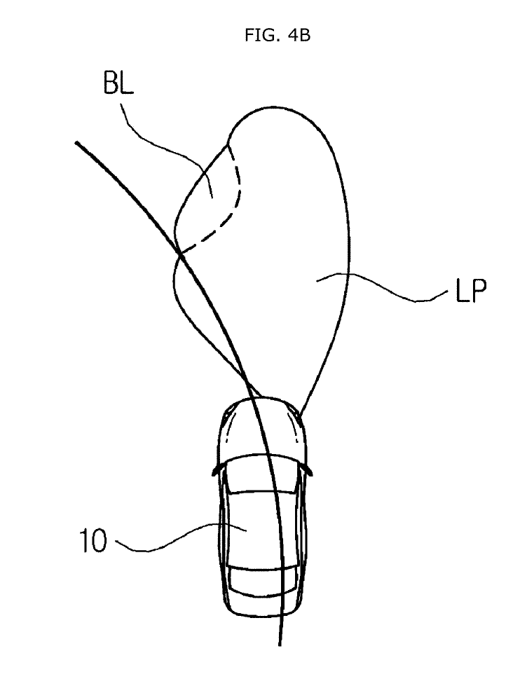

FIGS. 4A and 4B illustrate a forward region of the vehicle and a curved road region, where the low beam pattern LP and the bending light BL are created.

FIG. 4A shows the low beam pattern LP created by the vehicle 10 having an SWA of 0 degrees before entering the curved road.

FIG. 4B shows the low beam pattern LP and the bending light BL which are created by the vehicle 10 having a predetermined SWA after entering the curved road.

Therefore, the vehicle lamp apparatus 100 in accordance with the embodiment of the present invention can irradiate the bending light BL onto the curved road region where the low beam pattern LP is not formed depending on the SWA of the vehicle, in the forward region of the vehicle, and the low beam pattern LP can be expanded to the curved road region by the bending light BL.

Furthermore, the vehicle lamp apparatus 100 can ensure a wider range of visibility in a driving environment such as a curved road where an accident is highly likely to occur, without adjusting a lamp irradiation angle through a separate actuator. Thus, the size of the vehicle lamp apparatus can be minimized, and a user who gets a wide range of visibility can safely drive the vehicle, which makes it possible to improve the safety of the vehicle.

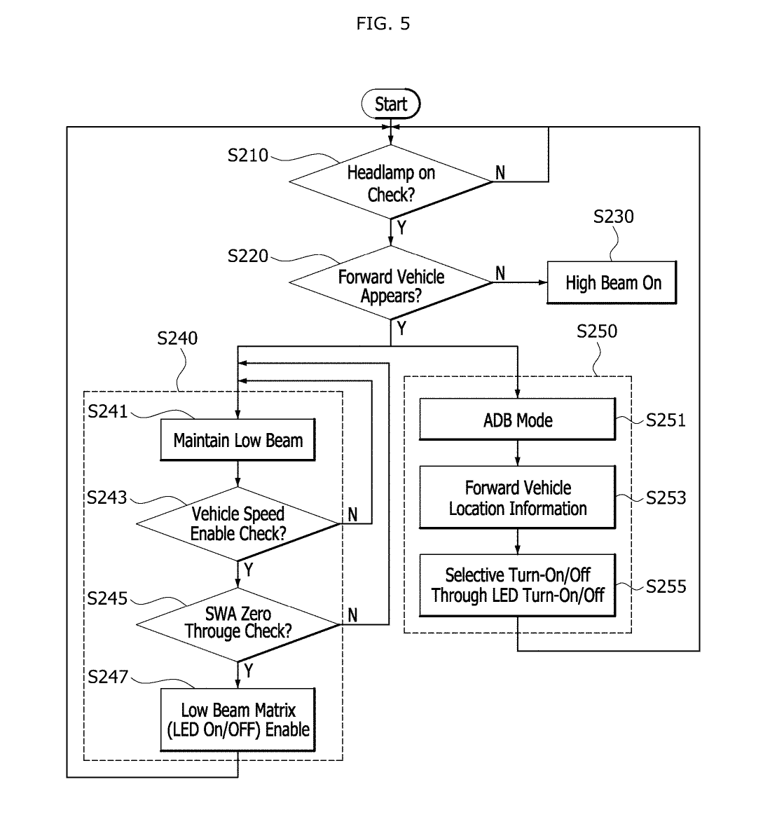

Referring to FIG. 5, a control method of the vehicle lamp apparatus 100 in accordance with an embodiment of the present invention will be described.

The control method of the vehicle lamp apparatus 100 may first check whether the vehicle lamp apparatus 100 is started (headlamp on check), at step S210. The vehicle lamp apparatus 100 may be started when the vehicle is operated in the night time.

Then, when the vehicle lamp apparatus 100 is started, the control method may sense whether an object, for example, a forward vehicle appears around the vehicle, at step S220.

Then, when there is no object around the vehicle, a high beam may be created through a separate lamp apparatus at step S230.

On the other hand, when an object around the vehicle is sensed, step S240 of creating a low beam pattern or step S250 of irradiating bending light may be performed.

The first lamp 110 of the vehicle lamp apparatus 100 may create a low beam pattern at step S241. The low beam pattern may be continuously maintained after being created, regardless of whether an object around the vehicle is sensed at step S220 after step S210.

Then, the control method may check whether the vehicle speed is enabled, at step S243. At this time, when the vehicle speed is less than a reference speed, the control method may return to step S241.

When the vehicle speed is equal to or more than the reference speed, the control method may check an SWA of the vehicle at step S245. At this time, when the SWA of the vehicle is less than a reference SWA, the control method may return to step S241.

When the SWA is equal to or more than the reference SWA, a low beam matrix may be enabled at step S247. The low beam matrix may be enabled depending on whether the LEDs of the first light source are turned on/off.

Hereafter, step S250 of irradiating bending light after the object around the vehicle is sensed at step S220 will be described.

The vehicle lamp apparatus 100 may be operated in an ADB (Adaptive Driving Beam) mode at step S251.

Then, the control method may measure forward vehicle location information in the ADB mode at step S253.

Then, depending on the forward vehicle location information, the control method may selectively turn on/off the LEDs of the second lamp 120. At this time, the LEDs of the second lamp 120 may be selectively turned on/off in consideration of the SWA and vehicle speed as well as the forward vehicle location information.

In accordance with the embodiments of the present invention, the vehicle lamp apparatus can irradiate the bending light onto the curved road region where the low beam pattern is not formed depending on the SWA of the vehicle, in the forward region of the vehicle, and the low beam pattern can be expanded to the curved road region by the bending light.

Furthermore, the vehicle lamp apparatus can ensure a wider range of visibility in a driving environment such as a curved road where an accident is highly likely to occur, without adjusting a lamp irradiation angle through a separate actuator. Thus, the size of the vehicle lamp apparatus can be minimized, and a user who gets a wide range of visibility can safely drive the vehicle, which makes it possible to improve the safety of the vehicle.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A vehicle lamp apparatus comprising:
a first lamp configured to create a low beam pattern in a forward region of a vehicle; and
a second lamp configured to irradiate bending light onto a curved road region where the low beam pattern is not formed depending on an SWA (Steering Wheel Angle) of the vehicle, in the forward region of the vehicle,
wherein the second lamp comprises:
a second light source comprising a plurality of LEDs which are independently turned on/off; and
a second reflector configured to reflect the bending light of the second light source onto the curved road region.

2. The vehicle lamp apparatus of claim 1, wherein the low beam pattern is expanded by the bending light of the second lamp.

3. The vehicle lamp apparatus of claim 2, wherein the plurality of LEDs included in the second light source are selectively turned on depending on the SWA.

4. The vehicle lamp apparatus of claim 3, wherein when the SWA is equal to or more than a preset reference SWA, the entire LEDs are turned on.

5. The vehicle lamp apparatus of claim 4, wherein the plurality of LEDs are turned on/off depending on a preset speed value of the vehicle.

6. The vehicle lamp apparatus of claim 3, further comprising a sensor configured to sense an object around the vehicle,
wherein the plurality of LEDs are selectively turned on according to a sensing signal of the sensor.

7. The vehicle lamp apparatus of claim 2, wherein the second reflector has a reflecting surface formed in a direction facing the second light source, and
the second reflector is set to a reflecting angle for irradiating the bending light of the second light source onto the curved road region.

8. A control method of a vehicle lamp apparatus, comprising:
checking whether the vehicle lamp apparatus is started;
sensing whether an object is present around a vehicle, when the vehicle lamp apparatus is started; and
creating a low beam pattern or irradiating bending light when the object is sensed around the vehicle, and creating a high beam when the object is not sensed around the vehicle.

9. The control method of claim 8, wherein the creating of the low beam pattern comprises:
creating, by a first lamp of the vehicle lamp apparatus, the low beam pattern or maintaining the created low beam pattern;
checking whether a vehicle speed is enabled;
checking an SWA of the vehicle when the vehicle speed is equal to or more than a reference speed; and
enabling a low beam matrix when the SWA is equal to or more than a reference SWA.

10. The control method of claim 9, wherein when the vehicle speed is less than the reference speed or the SWA is less than the reference SWA, the first lamp of the vehicle lamp apparatus creates the low beam pattern or maintains the created low beam pattern.

11. The control method of claim 8, wherein the irradiating of the bending light comprises:
operating the vehicle lamp apparatus in an ADB (Adaptive Driving Beam) mode;
measuring location information of a forward vehicle in the ADB mode; and
performing selective turn-on/off by turning on/off LEDs included in a second lamp of the vehicle lamp apparatus, according to the location information of the forward vehicle.
